(19) United States
(12) Patent Application Publication
(10) Pub. No.: US 2015/0373142 A1
(43) Pub. Date: Dec. 24, 2015

(54) FACILITATING MULTIPLE INTERACTION MODES WITHIN A SOCIAL DISCOVERY SERVICE

(71) Applicant: Foxlike Incorporated, Seattle, WA (US)

(72) Inventor: Susie Jungune LEE, Seattle, WA (US)

(21) Appl. No.: 14/309,824

(22) Filed: Jun. 19, 2014

(51) Int. Cl. H04L 29/08

(52) U.S. Cl. CPC H04L 67/306; H04L 67/10

(57) ABSTRACT

Systems and methods for managing the interactions between users or members of a social discovery service, enabling users or members to control their social discovery environments, is described. In some embodiments, the systems and methods access a member type assigned to a member of a social discovery service, the member type based on an interaction interest (e.g., the member is female and looking to meet males, or vice versa) provided by the member, and provides an interaction mode of the social discovery service to the member based on the accessed member type.

### BACKGROUND

Online dating sites and other social discovery services facilitate connections between people. For example, users of an online dating site may create profile pages having photos, videos, interest information, biographical information, and other content representative of the users and presented to pique the interests of other users of the site. Via various communication mechanisms supported by the site (e.g., messaging, posting, liking), interested parties may communicate with one another in order to meet one another.

Social discovery services provide various different environments in which users may meet other users. For example, some social discovery services facilitate connections between users within a similar location, some facilitate connections between users having shared interests or matched personalities. Also, many of these social discovery services enable users, such as those users who subscribe to a service, to initiate communications with any other user of the services, which may lead to unintended or unwanted interactions between users (e.g., harassment of users, unreliable or deceitful communications, and so on).

### BRIEF DESCRIPTION OF THE DRAWINGS

FIG. 1 is a block diagram illustrating components of a suitable computing environment.

FIG. 2 is a block diagram illustrating components of a member interaction system within a social discovery service.

FIG. 3 is a flow diagram illustrating a method for providing an interaction mode to a member of a social discovery service.

FIG. 4 is a flow diagram illustrating a method for modifying a level of interaction for a first member based on an action performed by a second member.

FIGS. 5A-5E are display diagrams illustrating example interactions between members of a social discovery service.

### DETAILED DESCRIPTION

### Overview

Systems and methods for managing the interactions between users or members of a social discovery service and/or enabling users or members to control their social discovery environments, are described. In some embodiments, the systems and methods access a member type assigned to a member of a social discovery service, the member type based on an interaction interest (e.g., the member is female and looking to meet males, or vice versa) provided by the member, and provides an interaction mode of the social discovery service to the member based on the accessed member type.

For example, when the gender of the member is female, the systems and methods provide an enhanced control interaction mode of the social discovery service to the member, and when the gender of the member is male, the systems and methods provide a limited control interaction mode of the social discovery service to the member.

In some embodiments, the systems and methods provide a limited control interaction mode of the social discovery service to a male member of the social discovery service, the limited control interaction mode associated with preventing the male member from accessing profile pages of female members of the social discovery service, receive input from one or more female members of the social discovery service to modify the limited control interaction mode of the social discovery service provided to the male member, and provide a modified control interaction mode to the male member based on the received input, the modified control interaction mode associated with allowing the male member to access one or more profile pages of female members of the social discovery service.

The systems and methods will now be described with respect to various embodiments. The following description provides specific details for a thorough understanding of, and enabling description for, these embodiments of the system. However, one skilled in the art will understand that the system may be practiced without these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable Computing Environment

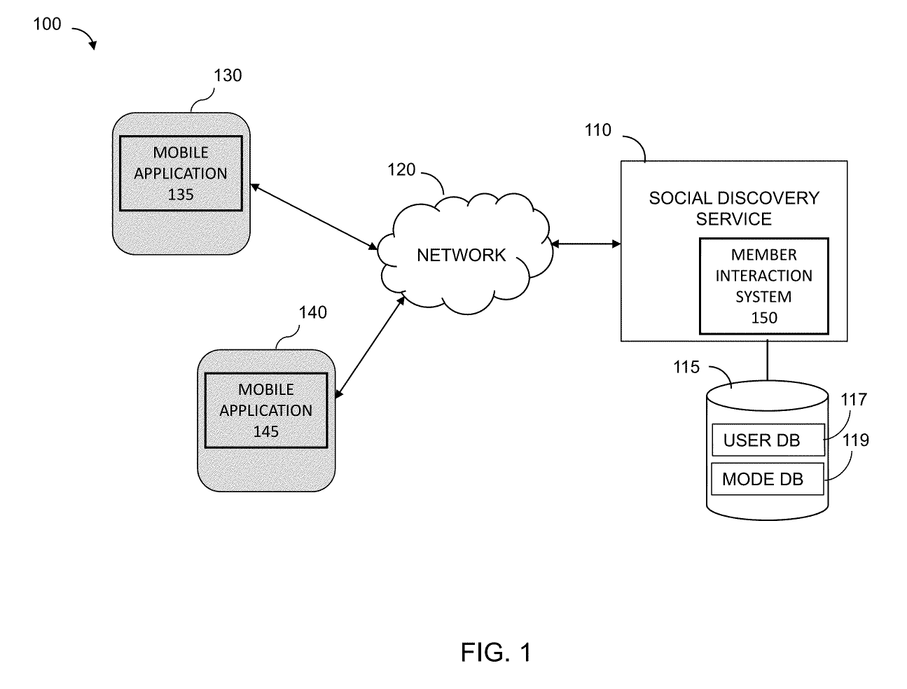

As described herein, a social discovery service may include a system configured to manage different modes or levels of interaction provided to members of the social discovery service. FIG. 1 is a block diagram illustrating components of a suitable computing environment 100 that includes the social discovery service 110. The computing environment 100 includes member devices 130, 140, which support and/or run mobile applications or browsers 135, 145 that display or provide information to members of the social discovery service 110. The mobile applications 135, 145 communicate with the social discovery service 110, which may be provided by a server or servers, over a network 120, such as the Internet, a telecommunication network, or other communication networks.

The member devices 130, 140 may be a tablet computer, mobile device, smart-phone, net-book, mobile GPS navigation device, remote control, fixed telephone or communications console or apparatus, surface or tabletop computer, overhead image projector, desktop computer, server computer, or any other computing system. The member devices 130, 140 include various hardware and/or software components in order to provide certain functionality. For example, the member devices 130, 140 include various human interface components, device components, and memory, and so on. The network 120 may be a Local Area Network (LAN), a Wide Area Network (WAN), the Internet, a GSM or LTE telecommunications network, a short range network, or other networks capable of facilitating various communications between computing devices.

FIG. 1 and the discussion herein provide a brief, general description of a suitable computing environment in which the systems and methods can be supported and implemented. Although not required, aspects of the system are described in the general context of computer-executable instructions, such as routines executed by a general-purpose computer, e.g., mobile device, a server computer, or personal computer. Those skilled in the relevant art will appreciate that the systems and methods can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the systems and methods can be embodied in a special purpose computing device or data processor that is specifically programmed, configured, or constructed to perform one or more of the computer-executable instructions explained in detail herein. Aspects of the systems and methods may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the systems and methods may be stored or distributed on computer-readable media (e.g., physical and/or tangible computer-readable storage media), including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

In some embodiments, the social discovery service 110 includes a member interaction system 150 that manages the mode or level of interaction available to and provided to the members of the social discovery service 110, as well as a storage device 115 that includes member information 117 and interaction mode information 119. The social discovery service 110, which may include or be part of an online dating site or service, a social network site or service, or other online communities that have users or members, may utilize the member interaction system 150 to provide a controlled (e.g., member controlled) environment in which to discover other members and interact with other members, among other things.

### Examples of Managing Interactions Between Members of a Social Discovery Service

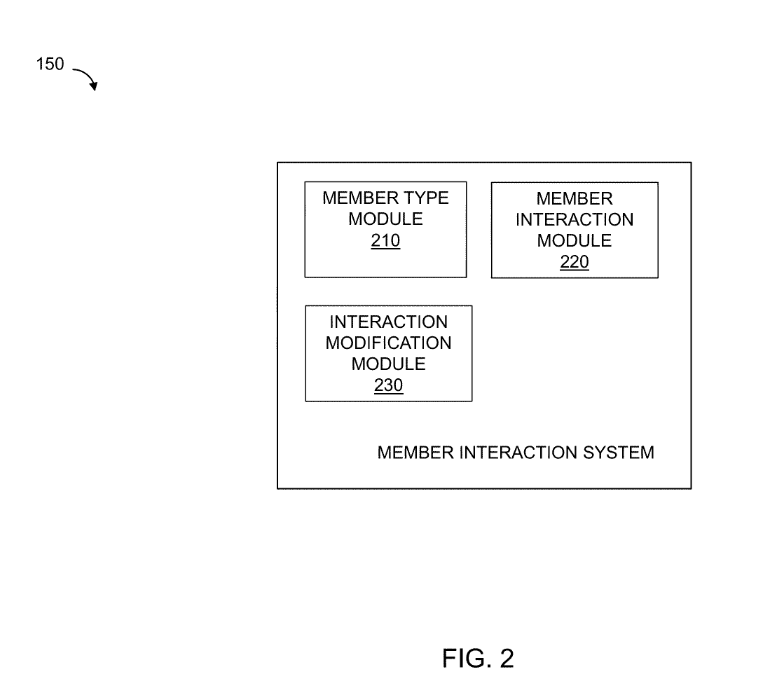

As described herein, a social discovery service 110 may utilize the member interaction system 150 in order to provide a managed, controlled, and/or varying level of interaction to different types of members of the social discovery service 110. FIG. 2 is a block diagram illustrating components of the member interaction system 150, which may include one or more modules and/or components to perform one or more operations of the member interaction system 150. The modules may be hardware, software, or a combination of hardware and software, and may be executed by one or more processors. For example, the member interaction system 150 may include a member type module 210, a member interaction module 220, and an interaction modification module 230.

In some embodiments, the member type module 210 is configured and/or programmed to access or receive a member type assigned to a member of the social discovery service 110, the member type based on an interaction interest provided by the member. For example, the member type module 210 may access information stored in the user database 117, such as member type information that is based on biographical information for the members of the social discovery service 110.

As described herein, the member type information may be based on a sex or gender of the member (e.g., male, female, cis, bigender, trans, and others), based on a target sex or gender for the member (e.g., the sex or gender of other members), based on a combination of gender and member interests, and so on. For example, the member type information may indicate a member is a “male” or a “female,” and/or may may indicate a member is a “male seeking other males,” a “female seeking other females, a “male seeking females,” a “female seeking males,” and various different combination of the gender types described herein and chosen or selected by the members of the social discovery service 110.

As another example, when the social discovery service 110 is a matchmaking service or provides an online dating site or portal, the interaction interest associated with the member includes a gender of the member provided by the member or a target gender provided by the member that identifies a gender of other members of the social discovery service 110 to whom the member wishes to interact, view, communicate, or otherwise discover.

In some embodiments, the member interaction module 220 is configured and/or programmed to provide an interaction mode of the social discovery service 110 to the member that is based on the accessed member type. For example, the member interaction module 220 may provide a limited control interaction mode to members of a first type (e.g., male members), and provide an unlimited or enhanced interaction mode to members of a second type (e.g., female members and/or selected male members). The member interaction module 220 may retrieve or otherwise access information stored in the mode database 119, such as information identifying various parameters for different interaction modes to be provide to the members of the social discovery service 110.

The member interaction module 220 may provide the limited control interaction mode to members by preventing the member of the first type from accessing profile pages of members of the second type, preventing the member of the first type from accessing profile pages of members of the second type that have not provided input authorizing the member to view their profile pages, by preventing the member of the first type from initiating a message or other communication to members of the second type, and so on.

Similarly, the member interaction module 220 may provide an unlimited or enhanced interaction mode to members by providing the member of the second type with access to profile pages of all members of the social discovery service, by providing the member of the first type with access to profile pages of members of the second type that have provided input authorizing the member to view their profile pages, by providing the member of the first type with access to profile pages of members of the second type based actions performed by the member, by providing the member of the second type from initiating a message or other communication to members of the first type, and so on.

Thus, the member interaction module 220 may, when the gender of the member is female, provide an enhanced control interaction mode of the social discovery service to the member, when the gender of the member is male, provide a limited control interaction mode of the social discovery service to the member, when the target gender for the member is female, provide a limited control interaction mode of the social discovery service to the member, and/or when the target gender of the member is male, provide an enhanced control interaction mode of the social discovery service to the member.

In some embodiments, the interaction modification module 230 is configured and/or programmed to modify a limited control interaction mode provided to the member in response to an action performed by a member within the social discovery service 110. For example, the interaction modification module 230 may modify the limited control interaction mode provided to the member (e.g., a male member) in response to input received by a female member of the social discovery service 110, in response to input received by a group of female members of the social discovery service 110, and/or based on actions performed by the member. Example actions performed by the member may include answering one or more questions or challenges posed to the member by the social discovery service 110 or other members of the social discovery service 110, among other things.

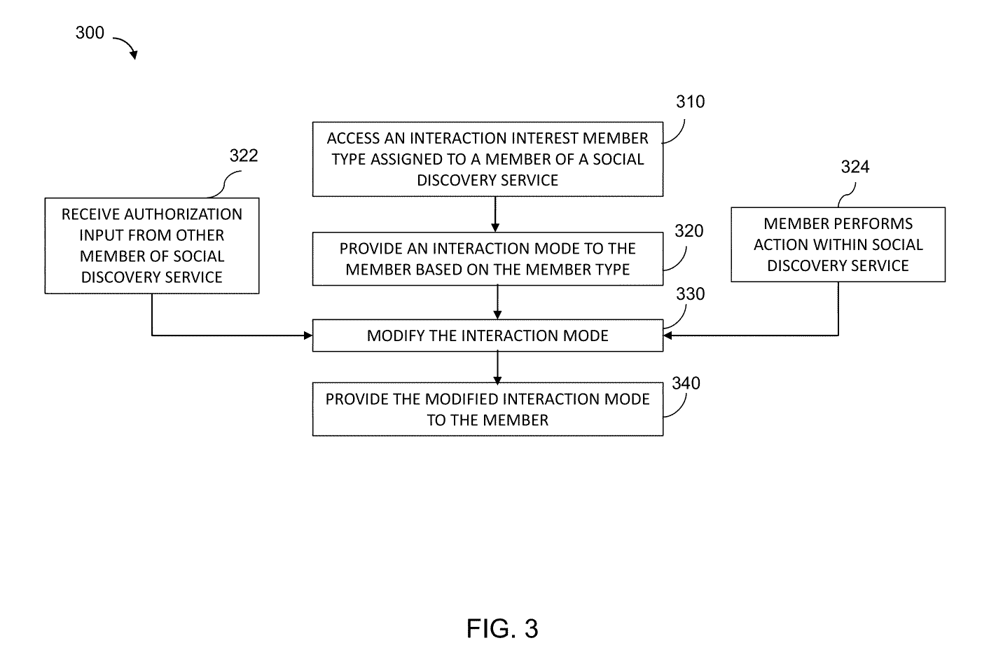

As described herein, the member interaction system 150 may perform various algorithms, routines, and/or methods when managing member interactions and controls within the social discovery service 110. FIG. 3 is a flow diagram illustrating a method 300 for providing an interaction mode to a member of a social discovery service. The method 300 may be performed by the member interaction system 150 and, accordingly, is described herein merely by way of reference thereto. It will be appreciated that the method 300 may be performed on any suitable hardware.

In operation 310, the member interaction system 150 accesses a member type assigned to a member of the social discovery service 110, the member type based on an interaction interest provided by the member. For example, the member type module 210 may access information stored in the user database 117, such as member type information that is based on biographical information for the members of the social discovery service 110.

As described herein, the member type information may be based on a sex or gender of the member (e.g., male, female, cis, bigender, trans, and others), based on a target sex or gender for the member (e.g., the sex or gender of other members), based on a combination of gender and member interests, and so on. For example, the member type information may indicate a member is a “male” or a “female,” and/or may may indicate a member is a “male seeking other males,” a “female seeking other females, a “male seeking females,” a “female seeking males,” and various different combination of the gender types described herein and chosen or selected by the members of the social discovery service 110.

In operation 320, the member interaction system 150 provides an interaction mode of the social discovery service 110 to the member based on the accessed member type. For example, the member interaction module 220 may provide a limited control interaction mode to members of a first type (e.g., male members), and provide an unlimited or enhanced interaction mode to members of a second type (e.g., female members and/or selected male members).

The member interaction module 220 may provide the limited control interaction mode to members by preventing the member of the first type from accessing profile pages of members of the second type, preventing the member of the first type from accessing profile pages of members of the second type that have not provided input authorizing the member to view their profile pages, by preventing the member of the first type from initiating a message or other communication to members of the second type, and so on.

As described herein, the member interaction system 150 may modify a current or provided interaction mode based on a variety of factors or actions performed by the members within the social discovery service 110. For example, in operation 322 the member interaction system 150 receive authorization input from another member of the social discovery service 110. As another example, the member interaction system 150, in operation 324, receives an indication or access information indication the member has performed an action within the social discovery service 110, such as an action (e.g., answers a challenge) that is associated with providing an enhanced interaction mode to the member.

In operation 330, the member interaction system 150 modifies the interaction mode provided to the member of the social discovery service 110, and, in operation 340, provides the modified interaction mode to the member. For example, the interaction modification module 230 may modify the limited control interaction mode provided to the member (e.g., a male member) in response to input received by a female member of the social discovery service 110, in response to input received by a group of female members of the social discovery service 110, and/or based on actions performed by the member. Example actions performed by the member may include answering one or more questions or challenges posed to the member by the social discovery service 110 or other members of the social discovery service 110, among other things.

Thus, in some embodiments, the member interaction system 150 may enable and/or provide the following member interaction environments for the members of the social discovery service 110:

When the gender of the member is female, providing an enhanced control interaction mode of the social discovery service to the member, and when the gender of the member is male, providing a limited control interaction mode of the social discovery service to the member;

When the target gender for the member is female, providing a limited control interaction mode of the social discovery service to the member, and when the target gender of the member is male, providing an enhanced control interaction mode of the social discovery service to the member;

Providing a female member with access to profile pages of all male members of the social discovery service, and preventing a male member from accessing profile pages of female members of the social discovery service;

Enabling a male member to access a first set of profile pages of female members of the social discovery service that have provided input authorizing the male member to view their profile pages, and preventing the male member from accessing a second set of profile pages of female members of the social discovery service that have not provided input authorizing the male member to view their profile pages;

Enabling a male member to access a first set of profile pages of female members of the social discovery service in response to an action performed by the male member within the social discovery service 110;

Enabling a male member to access a first set of profile pages of female members of the social discovery service 110 in response to authorization input received from a threshold number of female members of the social discovery service;

Enabling a male member to access a first set of profile pages of female members of the social discovery service for a certain time period in response to an action performed by the male member within the social discovery service 110;

Enabling a male member to access a first set of profile pages of female members of the social discovery service for a certain time period in response to authorization input received from a threshold number of female members of the social discovery service 110;

Providing a controlled level of interaction associated with viewing profile pages of other members of the social discovery service that is based on the member type of the member, and providing an uncontrolled level of interaction associated with performing actions within the social discovery service 110;

Providing a controlled level of interaction associated with communication between members of the social discovery service that is based on the member type of the member, and providing an uncontrolled level of interaction associated with performing actions within the social discovery service 110; and so on.

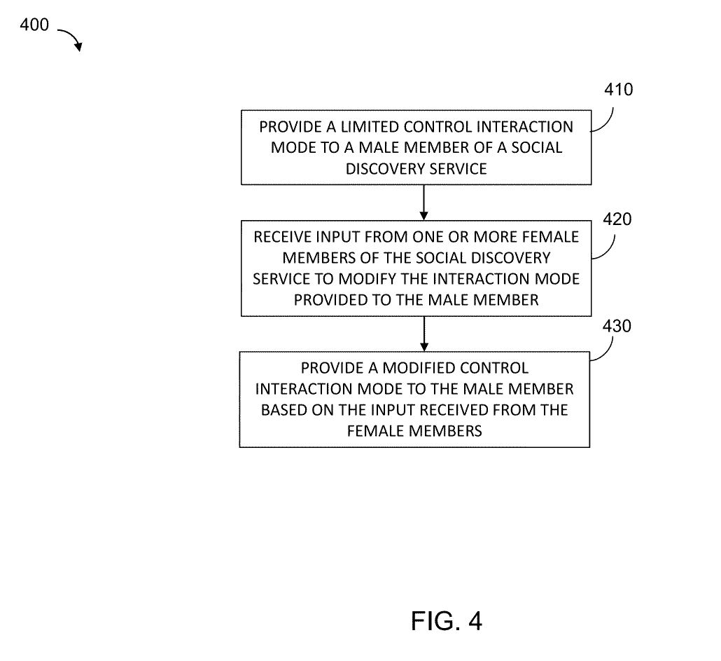

In some embodiments, the social discovery service 110 may enhance or otherwise modify the interaction mode for a member (e.g., a male member) based on an action or input provided by another member or members (e.g., female members). FIG. 4 is a flow diagram illustrating a method 400 for modifying a level of interaction for a first member based on an action performed by a second member. The method 400 may be performed by the member interaction system 150 and, accordingly, is described herein merely by way of reference thereto. It will be appreciated that the method 400 may be performed on any suitable hardware.

In operation 410, the member interaction system 150 provides a limited control interaction mode of the social discovery service 110 to a male member of the social discovery service, the limited control interaction mode associated with preventing the male member from accessing profile pages of female members or initiating a communication with female members of the social discovery service 110. For example, the member interaction module 220 may provide the limited control interaction mode to the male member based on member profile information indicating the gender of the member is male and the member seeks to discover other members having a gender of female.

In operation 420, the member interaction system 150 receives input from one or more female members of the social discovery service to modify the limited control interaction mode of the social discovery service provided to the male member. For example, the interaction modification module 230 may receive input from a single female member, a group of female members, a threshold number of female members, and so on.

In operation 430, the member interaction system 150 provides a modified control interaction mode to the male member based on the received input, the modified control interaction mode associated with allowing the male member to access one or more profile pages of female members and/or initiate communications to female members of the social discovery service 110. For example, the member interaction module 220 may allow the male member to access the profile pages of or initiate communication with female members that provided the input to the social discovery service 110, may allow the male member to access the profile pages of all female members of the social discovery service 110, and so on.

Thus, in some embodiments, the member interaction system 110 may facilitate and/or enable different interaction environments for members of the social discovery service 110, enabling the social discovery service 110 to provide a safe, enjoyable, and meaningful service to its members, among other benefits.

Examples Interactions within a Social Discovery Service

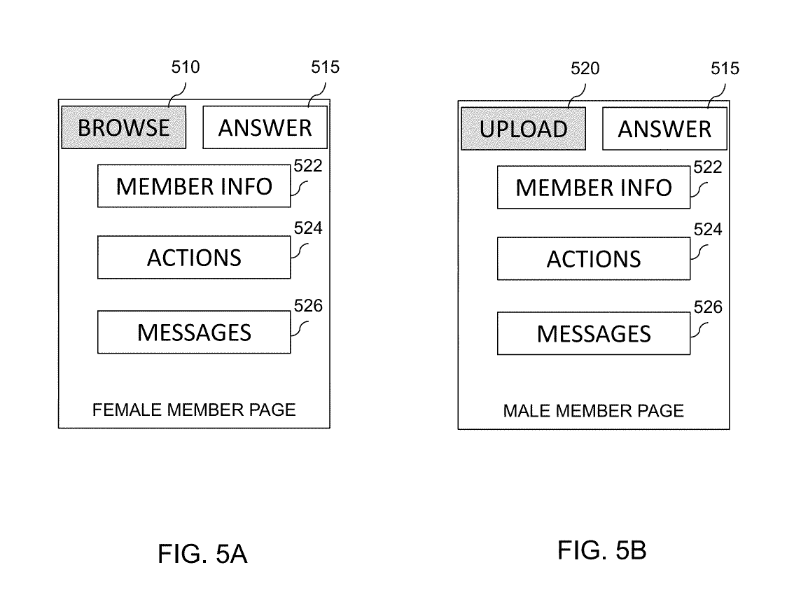

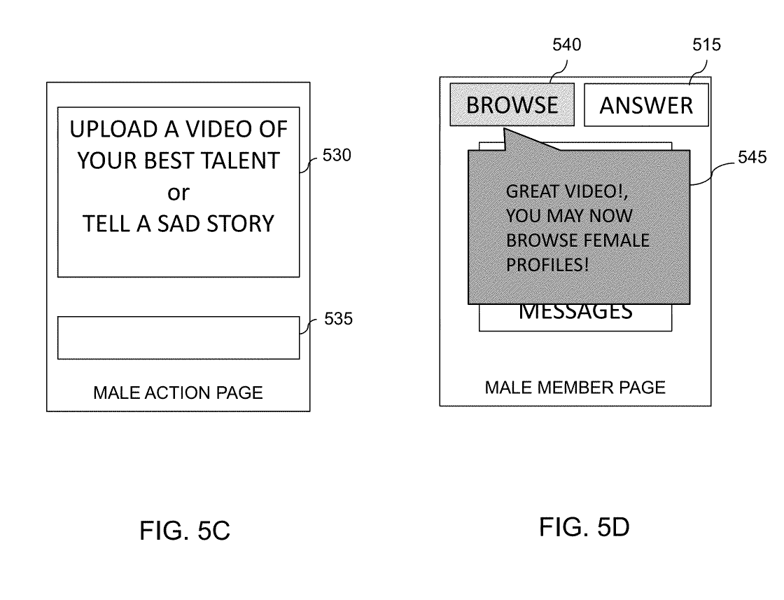

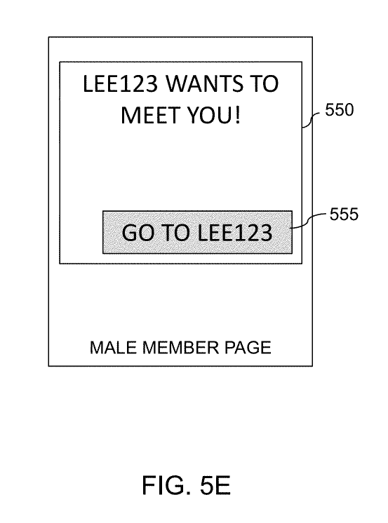

As described herein, the social discovery service 110 may utilize the member interaction system 150 and various processes described herein to manage the interactions between members of the social discovery service 110. FIGS. 5A-5E depict display diagrams that illustrate interactions between members of the social discovery service 110.

FIG. 5A depicts an example profile page for a female member of the social discovery service 110. The profile page may include, among other content, a user-selectable button or element 515 that, when selected, enables the member to perform an action (e.g., answer a question) within the service 110, member information 522, action or member activity information 524, messages or other interaction information 526, and other content (not shown). Based on the method performed in FIG. 3, the member interaction system 150 provides an enhanced interaction mode to the female member, and the profile page also includes user-selectable element 510 that, when selected, enables the member to browse profiles of other members, such as male members, of the social discovery service 110.

In contrast, FIG. 5A depicts an example profile page for a male member of the social discovery service 110. The profile page may also include, among other content, a user-selectable button or element 515 that, when selected, enables the member to perform an action (e.g., answer a question) within the service 110, member information 522, action or member activity information 524, messages or other interaction information 526, and other content (not shown). Based on the method performed in FIG. 3, the member interaction system 150 provides a limited interaction mode to the male member, and the profile page includes the user-selectable element 520 that, when selected, enables the member to add or upload additional content to his profile, but does not include button 510, thus preventing the male member from browsing or accessing profiles of female members of the social discovery service 110, among other limitations.

FIG. 5C depicts an example action page for a male member of the social discovery service 110. The action page includes an element 530 that identifies a task or challenge to perform, as well as an input element 535 via which the male member may provide input to answer or respond to the task or challenge. For example, the task or challenge may be to upload a video or image, provide written content, or otherwise respond with information about the member and/or his interests or views.

FIG. 5D depicts the male member page shown in FIG. 5B after the male member has responded to the challenge presented in element 530 of FIG. 5C. Based on the method performed in FIG. 3, the member interaction system 150 modifies the interaction mode provided to the male member, and the profile page includes button 540, which is associated with browsing the profile pages of female members, and associated instruction balloon 545, thus enabling the male member to browse the profiles of female members of the social discovery service 110, among other enhancements.

FIG. 5E depicts another male member page, where a female member (e.g., “LEE123”) has authorized the male member to view her profile page. The member page provides a content element 550 identifying the female member, as well as a user-selectable button 555 that, when selected, provide the male member with access to the profile page of LEE123 within the social discovery service 110.

Of course, the member interaction system 110 may enable or facilitate interactions not shown in the example profile pages depicted in FIGS. 5A-5E. For example, profile or member pages of the social discovery service 110 may include elements that enable members of certain types to control their visibility or access to other members, may include interactions that enable third party members to facilitate interactions between members (e.g., between members of a first type provided an enhanced interaction mode and members of a second type provided a limited or controlled interaction mode), may include elements that members to control their visibility or access in a real-time, instantaneous, and/or session or time-based manner, and so on.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device, the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. Accordingly, the inventors reserve the right to add additional claims after filing the application to pursue such additional claim forms for other aspects of the system.

We claim:

1. A method, comprising:
accessing a member type assigned to a member of a social discovery service, the member type based on an interaction interest provided by the member; and
providing an interaction mode of the social discovery service to the member based on the accessed member type.

2. The method of claim 1, wherein the member type includes a gender of the member, and wherein providing an interaction mode to the member based on the gender of the member includes:
when the gender of the member is female, providing an enhanced control interaction mode of the social discovery service to the member; and
when the gender of the member is male, providing a limited control interaction mode of the social discovery service to the member.

3. The method of claim 1, wherein the member type includes a target gender for the member, and wherein providing an interaction mode to the member based on the target gender for the member includes:
when the target gender for the member is female, providing a limited control interaction mode of the social discovery service to the member; and
when the target gender of the member is male, providing an enhanced control interaction mode of the social discovery service to the member.

4. The method of claim 1, wherein the member is female, and wherein providing an interaction mode of the social discovery service to the member based on the accessed member type includes providing the female member with access to profile pages of all male members of the social discovery service.

5. The method of claim 1, wherein the member is male, and wherein providing an interaction mode of the social discovery service to the member based on the accessed member type includes preventing the male member from accessing profile pages of female members of the social discovery service.

6. The method of claim 1, wherein the member is male, and wherein providing an interaction mode of the social discovery service to the member based on the accessed member type includes:
enabling the male member to access a first set of profile pages of female members of the social discovery service that have provided input authorizing the male member to view their profile pages; and
preventing the male member from accessing a second set of profile pages of female members of the social discovery service that have not provided input authorizing the male member to view their profile pages.

7. The method of claim 1, wherein the member is male, and wherein providing an interaction mode of the social discovery service to the member based on the accessed member type includes:
enabling the male member to access a first set of profile pages of female members of the social discovery service in response to an action performed by the male member within the social discovery service.

8. The method of claim 1, wherein the member is male, and wherein providing an interaction mode of the social discovery service to the member based on the accessed member type includes:
enabling the male member to access a first set of profile pages of female members of the social discovery service in response to authorization input received from a threshold number of female members of the social discovery service.

9. The method of claim 1, wherein the member is male, and wherein providing an interaction mode of the social discovery service to the member based on the accessed member type includes:
enabling the male member to access a first set of profile pages of female members of the social discovery service for a certain time period in response to an action performed by the male member within the social discovery service.

10. The method of claim 1, wherein the member is male, and wherein providing an interaction mode of the social discovery service to the member based on the accessed member type includes:
enabling the male member to access a first set of profile pages of female members of the social discovery service for a certain time period in response to authorization input received from a threshold number of female members of the social discovery service.

11. The method of claim 1, wherein the social discovery service is a matchmaking service, and wherein the interaction interest provided by the member includes a gender of the member provided by the member or a target gender provided by the member that identifies a gender of other members of the social discovery service to whom the member wishes to interact.

12. The method of claim 1, wherein the social discovery service is a matchmaking service, and wherein providing an interaction mode of the social discovery service to the member based on the accessed member type includes:
providing a controlled level of interaction associated with viewing profile pages of other members of the social discovery service that is based on the member type of the member; and
providing an uncontrolled level of interaction associated with performing actions within the social discovery service.

13. The method of claim 1, wherein the social discovery service is a matchmaking service, and wherein providing an interaction mode of the social discovery service to the member based on the accessed member type includes:
providing a controlled level of interaction associated with communication between members of the social discovery service that is based on the member type of the member; and
providing an uncontrolled level of interaction associated with performing actions within the social discovery service.

14. A system for managing interactions between members of a social discovery service, the system comprising:
a member type module that accesses a member type assigned to a member of a social discovery service, the member type based on an interaction interest provided by the member; and
a member interaction module that provides an interaction mode of the social discovery service to the member based on the accessed member type.

15. The system of claim 14, wherein the member is a male member who is provided a limited control interaction mode of the social discovery service, the system further comprising:
an interaction modification module that modifies the limited control interaction mode provided to the member in response to an action performed by member within the social discovery service.

16. The system of claim 14, wherein the member is a male member who is provided a limited control interaction mode of the social discovery service, the system further comprising:
an interaction modification module that modifies the limited control interaction mode provided to the member in response to input received by a female member of the social discovery service.

17. The system of claim 14, wherein the member is a male member who is provided a limited control interaction mode of the social discovery service, the system further comprising:
an interaction modification module that modifies the limited control interaction mode provided to the member in response to input received by a group of female members of the social discovery service.

18. A computer-readable storage medium whose contents, when executed by a social discovery service, cause the social discovery service to perform operations, comprising:
providing a limited control interaction mode of the social discovery service to a male member of the social discovery service, the limited control interaction mode associated with preventing the male member from accessing profile pages of female members of the social discovery service;
receiving input from one or more female members of the social discovery service to modify the limited control interaction mode of the social discovery service provided to the male member; and
providing a modified control interaction mode to the male member based on the received input, the modified control interaction mode associated with allowing the male member to access one or more profile pages of female members of the social discovery service.

19. The computer-readable storage medium of claim 18, wherein providing a modified control interaction mode to the male member based on the received input includes allowing the male member to access the profile pages of female members that provided the input to the social discovery service.

20. The computer-readable storage medium of claim 18, wherein receiving input from one or more female members of the social discovery service to modify the limited control interaction mode of the social discovery service provided to the male member includes receiving input from a threshold number of female members; and wherein providing a modified control interaction mode to the male member based on the received input includes allowing the male member to access the profile pages all female members of the social discovery service.
